(19) United States
(12) Patent Application Publication
(10) Pub. No.: US 2011/0030253 A1
(43) Pub. Date: Feb. 10, 2011

(54) DECORATIVE PLAQUE, SYSTEM AND METHOD OF MAKING THE SAME

(76) Inventor: Raymond G. Fahey, ANRORA, CO (US)

Correspondence Address: Inventa Capital PCC, 1010 Parkway Trail, Bloomfield Hills, MI, 48302, US

(21) Appl. No.: 12/736,508

(22) PCT Filed: Feb. 19, 2010
(86) PCT No.: PCT/US2010/000486

§ 371 Date: Oct. 12, 2010

Related U.S. Application Data
(60) Provisional application No. 61/153,917, filed on Feb. 19, 2009.

(51) Int. Cl. G09F 7/00; B23P 19/00

(52) U.S. Cl. 40/584; 29/428

(57) ABSTRACT

A decorative plaque of the present invention has at least two layers or parts. One of the layers is a base layer and another layer is a cover or top layer. The base layer may be formed from any material such as wood, polymeric material, metal, or combination thereof. The cover layer is fabricated from a transparent polymeric material. A plurality of indicia are sandwiched between the base and cover layers to capture the time and place where the person attended the venue. A method of fabricating the wall plaque and a system are disclosed.

### RELATED APPLICATIONS

This non-provisional patent application claims priority to International Application serial number PCT/US2010/000486 filed on Feb. 19, 2010 claiming priority to a provisional application Ser. No. 61/153,917 filed on Feb. 19, 2009 and incorporated here by reference in its entirety.

### FIELD OF THE INVENTION

The present invention relates to decorative plaques and method of fabricating the same.

### BACKGROUND OF THE INVENTION

Decorative and award plaques are used to commemorate many events and occasions. Trophies are given for recognition of personal or team achievement, for participation in various sport events, to commemorate school graduations, etc. Usually, these plaques have plates which contain a symbol, picture, or device, the recipient's name, and other pertinent information. Other uses for such plaques may include personalized desk sets, and works of art. Most aesthetically acceptable plaques have been produced using plates made of a metallic or metal composite material that are usually gold or silver in color. Generally, these plates have been imprinted by engraving or etching methods. The plates are then commonly mounted to a base made either synthetic materials such as plastic natural materials such as wood or granite.

The art is replete with various decorative plaques and methods of fabricating the same. One of such prior art designs are disclosed in U.S. Pat. Nos. 6,205,692 to Kite, 5,834,073 to Greenblat et al., 5,827,581 to Cobb et al., 4,125,655 to Kanzelberger, 4,123,862 to Dyer et al., 3,949,506 to Benkowski, and 3,822,494 to Zivica.

The U.S. Pat. No. 4,125,655 to Kanzelberger teaches a plaque of a preselected size and shape having a wood grain surface thereon. A plastic layer may be cemented to the wood grain to be colored by one or more hot-stamping foils. By repeated stamping, a plaque may be given a progressively more attractive appearance. For example, a gold-colored background plate may have a silver-colored insert with, say black and red lines apparently engraved thereon. The U.S. Pat. No. 4,125,655 to Kanzelberger fails to teach or suggest either expressly or impliedly methods of fabricating the plaque wherein the user would be able to memorialize the user's personal experience at an event or venue, a particular geographic location of the venue or time of the event.

The U.S. Pat. No. 3,949,506 to Benkowski teaches an ornamental team plaque of plastic having a plurality of ornamental team unit members which are repositionably mounted on the face of a plastic body. Numerical indicators may be positioned along mounting means fixed to the plastic plaque so the selectively positioned ornamental team unit members may indicate the relative standings of the teams at any selected date, which may be indicated on the plaque. The U.S. Pat. No. 3,949,506 to Benkowski fails to teach or suggest either expressly or impliedly a method of fabricating the plaque wherein the user would be able to memorialize the user's personal experience at an event or venue, a particular geographic location of the venue or time of the event.

The U.S. Pat. No. 3,822,494 to Zivica teaches a wall plaque having an outer rim member fabricated from thermoplastic polystyrene with a surface finish resembling a wood grain. The rim member is provided with a central aperture receiving a concave dish-shaped center plate on which is mounted a decorative member representative of a sport, such as football or the like. Integrally molded to the concave surface of the center plate is indicia representative of the particular sport for example, the name of a football team, or the like. The rim member and center plate are fabricated in such a manner that they are interchangeable for use with different decorative members and indicia representative of different sports such that only one set of molds is required to fabricate the rim member and center plate, which rim member and center plate are interchangeably used in the fabrication of wall plaques representative of different sports and the like. The U.S. Pat. No. 3,822,494 to Zivica fails to teach or suggest either expressly or impliedly a method of fabricating the plaque wherein the user would be able to memorialize the user's personal experience at an event or venue, a particular geographic location of the venue or time of the event.

There has, therefore, been a longstanding need to improve methods and systems for fabricating decorative plaques wherein the user would be able to memorialize the user's personal experience at an event or venue, a particular geographic location of the venue and time of the event.

These and other problems have been solved by the improved system and method described below.

### SUMMARY OF THE INVENTION

A concept of the present invention has numerous industrial applications ranging from preparation of decorative plaques for sporting events to decorative plaques that reflect participation at various corporate venues, gatherings, school reunions, graduation parties and the like. The following application of the present invention is just one of the solutions and is not intended to limit the scope of the present invention.

The inventive concept presents a decorative plaque of various configurations ranging from a rectangular configuration to a circular configuration, a configuration having at least two planar sides and at least one semi-circular side, without limiting the scope of the present invention. The decorative plaque has at least two layers with one of the layers being a base layer and another layer being a cover or top layer. The base layer may be formed from any material such as wood, polymeric material, metal, or combination thereof, without limiting the scope of the present invention. The cover or top layer may be formed from a transparent material composed of glass or a polymeric material and may have a transparent coating, without limiting the scope of the present invention. Those skilled in the art will appreciate that there may be other additional layers combined with the base and top layers.

Alluding to the above, various indicia are sandwiched between the base layer and the top layer. The indicia may include the following: a picture of the person or person's who attended the event or locale; a ticket to the event or locale; a program or portion of a program from the event or locale; or other such event or locale specific indicia. Also alluding to the above, the surface may be imprinted with information about the event and about the user's personal experience while at the event or location. This information may include the name of the event or location, the location of the person at the time of purchase of the plaque of the present invention—including GPS data and resultant graphical display taken from the person's cell phone or communication device, the description of the event, a digitized version of the photograph that has been submitted by the person, or other information about the event or location.

The inventive concept also includes a method of purchasing the decorative plaque. The person who attends the venue purchases a ticket or pass to the event. Sometimes, the person may have obtained an autograph of a prominent personality who attends the event on the ticket or the pass. Additionally, the person may have his/her picture taken at the event with and/or without the prominent personality. For example, the picture may be taken with an actor or athlete or other person of interest or simply next to the arena or the stage. The person who attends the venue—such as a football game, a car racing competition, a seminar, a movie premier, etc, or locale such as a geographic or historic place of interest—may use their cell phone or any other data communication device to access the Internet site of the inventive system.

When the internet site is accessed, the person will be shown an example of the present invention and will be asked a series of questions including but not limited to personal information, a brief description of their experience at the event or locale, and the name and/or address of the venue or locale. Additionally, the person will be asked if they wish to upload a photograph that is pertinent to their experience at the event and they will be queried regarding the size and format of their purchased event ticket or other indicia they would like to have embedded in their plaque. The person will also be given the opportunity to share the GPS coordinates of their location from their cell phone or data communication device with the website in order to authenticate their attendance at the event or locale and to allow their customized plaque to carry a certification that they were indeed at the event or locale. The person will then be allowed to purchase their customized plaque immediately on the website. Alternatively, a person may order the product following the same process on a computer terminal after leaving the event or locale. In either ordering scenario, the person will be instructed to mail in their actual ticket via an overnight carrier envelope—supplied by the manufacturer—to be embedded in their customized plaque.

The inventive concept also involves a method for manufacturing delivery of the decorative plaque. When an order is placed by a purchaser on the website either via a handheld data communication device or via a computer terminal, the information will be transmitted to various facilities: a manufacturing facility will receive a production order for the individual plaque; a copywriting facility will receive the event or locale information; the payment information will be received by an accounting group; an international mail carrier will receive a delivery order for a return addressed, prepaid shipping envelope to be used by the purchaser to ship their ticket to the manufacturing facility.

The copywriting facility, upon receipt of the information will assign the order to a copywriter who will research the event or locale and will enter a feature article about the event or locale into the manufacturing production database. The international mail carrier, upon receipt of the information will dispatch a manufacturing facility addressed stamped envelop to the purchaser's address. The manufacturing facility, upon receipt of the information will schedule the production of the plaque. The production process will remain in a “pending” status until the ticket is received at the manufacturing facility. Upon receipt of the ticket, the manufacturer will produce the plaque using the copywriter's article, the purchaser's editorial about their personal experience, the purchaser's photograph of choice and the purchaser's ticket which was received in the mail. A specialized print machine will print a thematic background on the second surface of a piece of transparent material—either polymeric or glass using a UV resistant paint. On the front surface the print machine will transfer the copywriter's content, the purchaser's editorial comments and a digitized copy of the purchaser's photograph of choice. Additionally, the print machine will employ the logo and certification emblems on the front surface. All front surface printing will be applied using UV resistant paint. The plaque will then move to the assembly phase where the ticket will be semi-permanently mounted to the second surface of the plaque and a final cover coat will be applied to the second surface. The plaque will be mounted on a highly finished base made of wood, metal or other optional substrate. The manufacturer will then package and ship the plaque to the purchaser.

Accordingly, an objective of the present invention is to provide a uniquely individualized commemorative piece memorializing the purchaser's actual experience at the event. The plaque incorporates factual information from the event or locale, the purchaser's experience in his or her own words, a photograph taken at the event, and the purchaser's actual ticket or pass for entry to the event.

Another objective of the present invention is to provide a unique ability to verify and certify the purchaser's actual attendance at the event or locale. If the plaque is ordered at the event or locale, data may be obtained from the purchaser's communication device's GPS software and will allow their location to be verified and certified.

Another objective of the present invention is to provide improved plaque materials, especially those having surfaces which allow a three dimensional presentation of the graphics, text and memorabilia associated with the plaque.

Still another object of the invention is to engage processes for making a decorative plaque with high contrast and superior aesthetic qualities.

Still another object is to provide a plaque which may be quickly, readily, and inexpensively manufactured, even on a single plaque basis

Still another object of the present invention is to provide methods of manufacturing a plaque which may be performed at the point of sale by persons having no special training.

Advantages and meritorious features of this invention will be more fully understood from the following description of the preferred embodiment, the appended claims, and the drawings, a brief description of which follows.

### BRIEF DESCRIPTION OF THE DRAWINGS

Other advantages of the present invention will be readily appreciated as the same becomes better understood by reference to the following detailed description when considered in connection with the accompanying drawings wherein:

FIGS. 1 illustrates a front view of a decorative plaque of the present invention;

FIG. 2 illustrates an exploded view of the decorative plaque of the present invention;

FIG. 4 illustrates a schematic view of the method of making the decorative plaque.

FIG. 5 illustrates a schematic view of the process for ordering the decorative plaque.

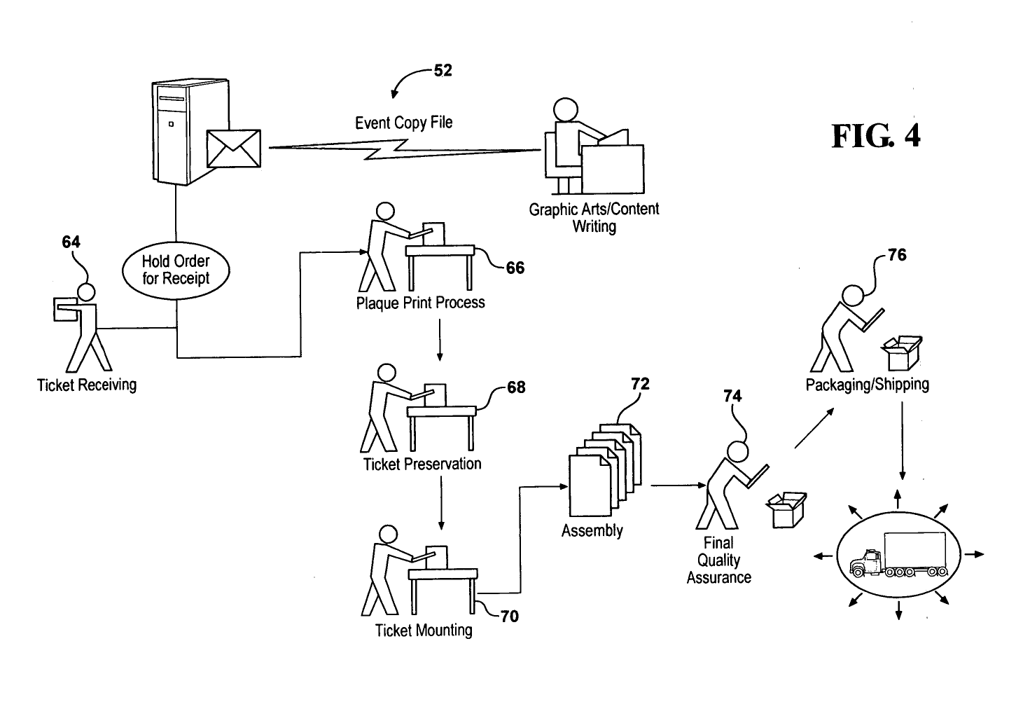

### DETAILED DESCRIPTION OF THE INVENTION

A concept of the present invention has numerous industrial applications ranging from preparation of decorative plaques for sporting events to decorative plates to reflect participation in various corporate venues, gatherings, school reunions, graduation parties and the like. The following application of the present invention, i.e. a decorative plaque is just one of the solutions and is not intended to limit the scope of the present invention.

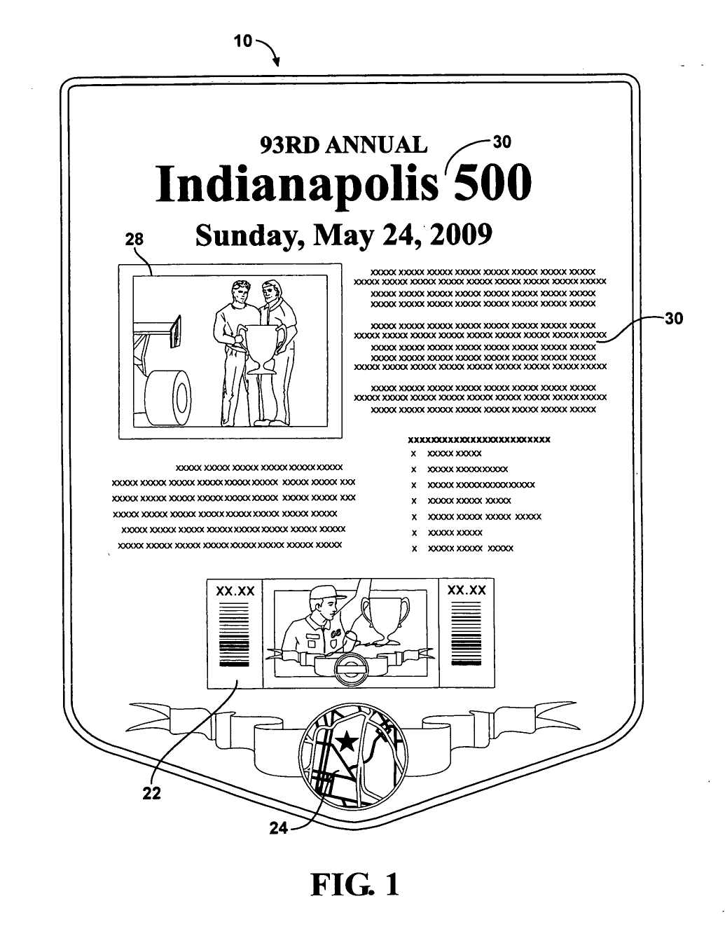

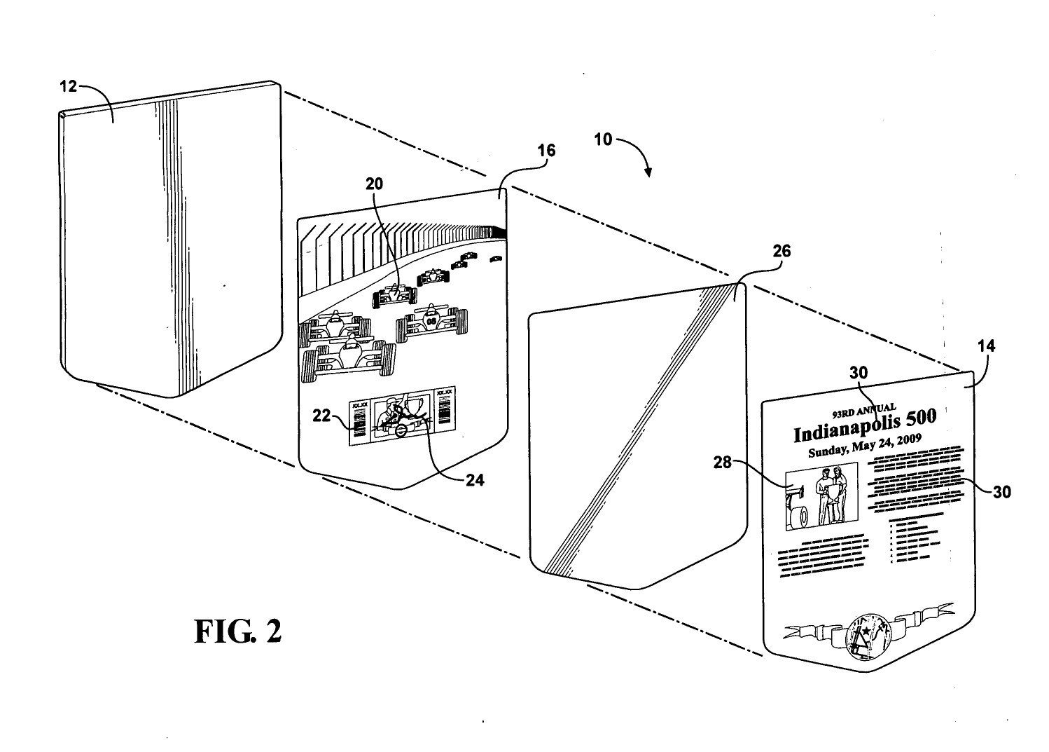

Referring to FIGS. 1 and 2, the inventive concept presents a decorative plaque, generally shown at 10, of various configurations ranging from a rectangular configuration to a circular configuration, a configuration having at least two planar sides and at least one semi-circular side, without limiting the scope of the present invention. The decorative plaque 10 has at least two layers with one of the layers being a base layer 12 and another layers being a cover or top layer 14. The base layer 12 may be formed from any material such as wood, polymeric material, metal, or combination thereof, without limiting the scope of the present invention. The cover or top layer 14 maybe formed from a transparent polymeric material, a coating, or other materials without limiting the scope of the present invention.

Those skilled in the art will appreciate that there may be other additional layers combined with the base and top layers 12 and 14. For example, a second surface layer 16 may be sandwiched between the base layer 12 and the top layer 14. The second surface layer 16 may include various backgrounds imprinted thereon to match the theme of the event. For example, as illustrated in FIG. 2, the plaque 10 includes a background 20 of a racing event, illustrated for exemplary purposes without limiting the scope of the present invention. A ticket 22 is connected to the second surface layer 16. The ticket 22 will also include a logo 24 depicting an image taken from the global positioning system or any other similar devices at the time when the person attended the event thereby certifying exact time and the location of the event attended. A layer of a transparent substrate 26 is positioned between the layers 16 and 14. The layers 16 and 26 may be fabricated from polymeric material, metal, or combination thereof, without limiting the scope of the present invention.

Alluding to the above, various other indicia are sandwiched between or on tope with the base layer 12 and the top layer 14. The indicia may include the following: a picture 28 of the person or person's who attended the event or locale; the ticket 22 to the event or locale; a program or portion of a program from the event or locale; or other such event or locale specific indicia. Also alluding to the above, the surface may be imprinted with information 30 about the event and about the user's personal experience while at the event or location. This information may include the name of the event or location, the location of the person at the time of purchase of the plaque of the present invention—including GPS data and resultant graphical display taken from the person's cell phone or communication device, the description of the event, a digitized version of the photograph that has been submitted by the person, or other information about the event or location.

Referring now to FIG. 3, a method of purchasing the decorative plaque of the inventive concept is generally shown at 40. The person 42 who attends the venue purchases a ticket or pass to the event. Sometimes, the person 42 may have obtained an autograph of a prominent personality who attends the event on the ticket or the pass. Additionally, the person 42 may have his/her picture taken at the event, as shown at 28 in FIGS. 1 and 2, with and/or without the prominent personality. For example, the picture may be taken with an actor or athlete or other person of interest or simply next to the arena or the stage. The person 42 who attends the venue—such as a football game, a car racing competition, a seminar, a movie premier, etc, or locale such as a geographic or historic place of interest, as shown in FIG. 3 at 44—may use their cell phone 46 or any other data communication device to access the Internet site of the inventive system.

When the interne site is accessed, as shown at 48, the person 42 will be shown an example of the present invention and will be asked a series of questions including but not limited to personal information, a brief description of their experience at the event or locale, and the name and/or address of the venue or locale. Additionally, the person 42 will be asked if they wish to upload a photograph that is pertinent to their experience at the event and they will be queried regarding the size and format of their purchased event ticket or other indicia they would like to have embedded in their plaque. The person 42 will also be given the opportunity to share the GPS coordinates of their location from their cell phone or data communication device with the website in order to authenticate their attendance at the event or locale and to allow their customized plaque to carry a certification that they were indeed at the event or locale. The person 42 will then be allowed to purchase their customized plaque immediately on the website.

Alternatively, a person may order the product following the same process on a computer terminal after leaving the event or locale. In either ordering scenario, the person will be instructed to mail in their actual ticket via an overnight carrier envelope—supplied by the manufacturer—to be embedded in their customized plaque 10.

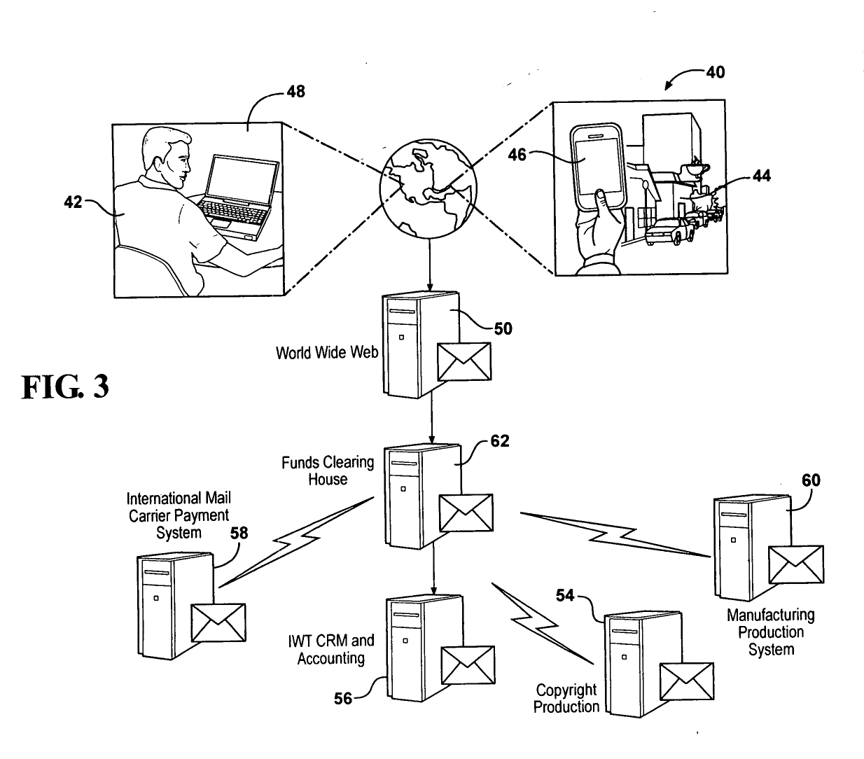

When an order is placed by the purchaser 42 on the website 50 either via the handheld data communication device, i.e. the cell phone 46 or via the computer terminal 48, the information will be transmitted to various facilities including and not limited to a manufacturing facility, generally shown at 52 in FIG. 4, which receives a production order for the individual plaque 10, a copywriting facility 54, which will receive the event or locale information, the payment information will be received by an accounting group 56; an international mail carrier 58, which receives a delivery order for a return addressed, prepaid shipping envelope to be used by the purchaser to ship their ticket to the manufacturing facility.

The copywriting facility 54, upon receipt of the information will assign the order to a copywriter who will research the event or locale and will enter a feature article about the event or locale into the manufacturing production database. The international mail carrier 58, upon receipt of the information will dispatch a manufacturing facility addressed stamped envelope to the purchaser's address. The manufacturing facility 60, upon receipt of the information will schedule the production of the plaque 10. The production process will remain in a “pending” status until the ticket 22 is received at the manufacturing facility 64.

Alluding to the above, upon receipt of the ticket 22, the manufacturer will produce the plaque 10 using the copywriter's article, the purchaser's editorial about their personal experience, the purchaser's photograph of choice and the purchaser's ticket which was received in the mail.

A specialized print machine will print a thematic background on the second surface 16 of a piece of transparent material—either polymeric or glass using a UV resistant paint. On the front surface the print machine will transfer the copywriter's content 30, the purchaser's editorial comments and a digitized copy of the purchaser's photograph of choice. Additionally, the print machine will employ the logo and certification emblems 24 on the front surface 14. All front surface printing will be applied using UV resistant paint. All these steps are illustrated at 66 through 7o in FIG. 4. The plaque 10 will then move to the assembly phase 72 where the ticket 22 will be semi-permanently mounted to the second surface 16 of the plaque 10 and a final cover coat 26 will be applied to the second surface 16. The plaque 10 will be mounted on a highly finished base 12 made of wood, metal or other optional substrate. The manufacturer will then control the final quality of the plaque 10 followed by packaging the plaque 10 and shipping the plaque 10 to the purchaser 42s shown in steps 74 and 76.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A decorative plaque for capturing time and location of an event taking place at a venue, said decorative plaque comprising:
a first portion having two opposite sides;
a second portion having two opposite sides and connected to said first portion,
a plurality of indicia associated with one of said opposite sides of said first portion and said second portion with said indicia; and
at least one element associated with at least one of said first portion and said second portion with said at least one element presenting image of a geographic location of the venue and time of the event.

2. A decorative plaque as set forth in claim 1, wherein said at least one element is a logo depicting an image of the venue taking from a distance by a global positioning system and a specific time when said image was taken thereby certifying the time and location of the event.

3. A decorative plaque as set forth in claim 2, wherein said logo may include at least two separate portions with one of said portions connected to at least one of said opposite sides of said first and second portions and the other of said portions connected to at least one of said opposite sides of said first and second portions.

4. A decorative plaque as set forth in claim 2, wherein said indicia is connected at least one of said opposite sides of said first and second portions and the other of said portions connected to at least one of said opposite sides of said first and second portions.

5. A decorative plaque as set forth in claim 2, wherein said first portion an said second portions are is fabricated from a non-polymeric material.

6. A decorative plaque as set forth in claim 2, wherein said first portion an said second portions are is fabricated from a polymeric material.

7. A method of fabricating a decorative plaque for capturing time and location of an event taking place at a venue, said decorative plaque comprising:
forming a first portion of the decorative plaque having two opposite sides;
forming a second portion of the decorative having two opposite sides with the two porting being connected to one another;
connecting a plurality of indicia to one of the opposite sides of the first portion and the second portion; and
taking at least one image of a geographic location of the venue and recording time of the event as the event takes place thereby connecting the at least one image taken to at least one of the first portion and the second portion.

8. A method as set forth in claim 7, wherein said at least one image is a logo depicting an image of the venue taking from a distance and a specific time when said image was taken to certify the time and place of the venue.

9. A method as set forth in claim 7, including the step of connecting the indicia to at least one of the opposite sides of the first and second portions and the other of the portions connected to at least one of the opposite sides of the first and second portions.

10. A method as set forth in claim 7, including the step of forming the first and second portions from a non-polymeric material.

11. A method as set forth in claim 7, including the step of forming the first and second portions from a polymeric material.
